(19) United States
(12) Patent Application Publication
(10) Pub. No.: US 2003/0044257 A1
(43) Pub. Date: Mar. 6, 2003

(54) Round hexagon screw and method for its production

(76) Inventors: Holger Siegel, Chemnitz (DE); Dierk Weigel, Adorf (DE)

Correspondence Address: HORST KASPER, 13 FOREST DRIVE, WARREN, NJ, 07059, US

(21) Appl. No.: 09/956,230

(22) Filed: Sep. 19, 2001

(30) Foreign Application Priority Data
Sep. 19, 2000 (DE) 100 46 562.5

(51) Int. Cl. F16B 35/06

(52) U.S. Cl. 411/402

(57) ABSTRACT

The invention concerns an outer hexagon round screw and a method for production of the screw. The screw cap is formed here essentially in the kind of a Torx head, with an outer hexagon round contour (5) and a flange (4) having a slope (4.1) reaching in the direction of the outer hexagon round contour (5) under an angle (alpha) thereby assuring a force engagement with a tool. The slope (4.1) of the flange (4) follows immediately to the outer hexagon round contour (5) such that the overall height (k) of the head (3) is substantially decreased, wherein at the same time the height (t₁) of the outer hexagon round contour (5) assures a reliable force engagement. The production of the flange (4) and of the outer hexagon round contour (5) is performed either by scraping with a scraping tool or by head flattening or upset compressing or compression molding, wherein additionally a socket is formed in the head region. (FIG. 1).

### BACKGROUND OF THE INVENTION

1. Field of the Invention

The invention relates to a round hexagon screw and a method for its production and wherein the screw head is formed substantially in the kind of a Torx head.

2. Brief Description of the Background of the Invention

A method for the production of a Torx (Trademark) screw exhibiting an outer round hexagon is known from U.S. Pat. No. 4,239,834, wherein the forming of the head is performed by backward extrusion and wherein the contour of the extrusion tool generates the outer hexagon round. Backward extrusion and flow pressing is a reduction of a cylindrical starting body with respect to the cross-section of the cylindrical starting body.

This method according to U.S. Pat. No. 4,239,834 is however associated with the disadvantage that the head of the completely formed outer round hexagon profile exhibits an extrusion incline in the direction toward the flange, which extrusion incline does not serve for attacking with a force of a tool and which extrusion incline unnecessarily increases the height of the head such that the total height of the head is more than triple the height of the outer hexagon round profile assuring the engagement of force. The extrusion incline reduces the effective height available for force attack and engagement by a tool. Furthermore expensive extrusion tools are required for the production.

### SUMMARY OF THE INVENTION

1. Purposes of the Invention

It is an object of the present invention to furnish a round hexagon screw and a method for its production, wherein the height of the head is substantially decreased for maintaining a reliable force engagement and wherein material can be saved and whereby it is possible to save expensive extrusion tools. The material to be saved is a wire forming starting material.

These and other objects and advantages of the present invention will become evident from the description which follows.

2. Brief Description of the Invention

The screw with the round hexagon head is of the kind of a Torx screw, wherein the head comprises a flange with an angle reaching in the direction toward the outer hexagon round and an outer hexagon round contour formed assuring a force engagement. The flange follows immediately to the outer hexagon round contour according to the present invention, wherein the height of the head is substantially decreased and wherein nevertheless the height of the profile of the outer hexagon round assures a reliable force engagement or force attack.

The ratio of the overall head height to the height of the outer hexagon round contour can be substantially minimized by this and comprises only 1.5 to 2.5, preferably 2, which means that the overall height of the head is only by a factor of 1.5 to 2.5 higher as compared to the height of the outer hexagon round contour. The flange here exhibits preferably an angle of essentially 15 degrees. Also a socket can be entered into the head, wherein the depth of the socket amounts to about 20 to 50 percent of the overall height of the head. The socket can be formed as a shaped inner profile, for example as an inner round hexagon, a hexagon socket or as an internal plurality of teeth. The wall thickness between the socket and the outer hexagon contour amounts to not more than 60 percent of the outer enveloping circle of the outer hexagon round profile depending on the outer enveloping circle of the respective inner profile. A cylindrical raw blank is reduced in cross-section during the production of the outer hexagon round screw with a head comprising an outer hexagon round contour assuring a force engagement and a flange with a slope reaching in the direction to outer hexagon round contour at an angle. In addition, a pre-form of the head is generated in a later head region. The finishing of the flange and of the outer hexagon round contour is performed by either scraping with a scraping tool or by upsetting or compression molding, wherein additionally a socket is generated in the head region according to the present invention. Compression molding is a deformation of a cylindrical starting body into an arbitrary body having a larger diameter.

During scraping, material is scraped from the region which forms the outer hexagon round contour into the flange region, whereby the flange is formed, through a scraping piston, wherein the scraping piston has an inner contour corresponding to the outer contour of the hexagon round and according to an expanding contour in the scraping direction corresponding to the angle of the flange to be generated. A counter tool engages at the bottom side of the pre-form of the head, wherein the lower side of the flange and the outer contour of the flange are formed in the counter tool during scraping. If required the flange can be cut at its outer diameter in the following.

It is also possible to form a socket in the preformed head region prior to or during scraping. In case the socket was generated prior to the scraping, then a piston penetrating through the scraping piston can engage into the socket during scraping such that no material can flow into the previously generated socket during scraping. Also the head with its outer contour and the socket can be formed simultaneously with the piston generating the socket and the scraping piston by combined scraping and extruding. The piston advantageously serves as an ejector. If required, a stripping sleeve can be employed for ejection in addition.

An outer hexagon round screw is created with the present invention, wherein the outer hexagon round screw exhibits a shape precise contour and a sharp edge contour and assures a sufficient force engagement face by a high outer hexagon round contour relative to the height of the head while providing a smaller height of the head.

The relevant parameters are defined as follows:

Head height K

Force attack height h

Cylindrical flange height x

Cylindrical flange height including slope c

The standing times or times of exposure of the mounting tools are also increased by the well formed contour. In addition a larger construction space becomes free in case of difficult accessible mounting positions and the deployment weight of the screw is minimized. This in turn enables higher filling amounts and thereby smaller expenses for packaging and distribution. The torque transferability is improved by the sharp edge contour. The socket with the inner profile can be employed additionally for force transfer and enables a safe assembly and mounting even in inaccessible locations.

Extensive extrusion tools are saved by the production of the outer hexagon round contour with scraping. A sharp edged contour is generated, wherein the sharp edge contour excludes a re-working or reduces a re-working to a minimum. The method combination in the form of socket formation, upsetting and compression molding while simultaneously generating a socket in the head region assures also a high quality of the head, wherein for example a cutting is avoided.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawing. The invention is in the following illustrated in more detail by way of the embodiments and the associated drawings.

### BRIEF DESCRIPTION OF THE DRAWING

In the accompanying drawing, in which are shown several of the various possible embodiments of the present invention:

FIG. 1 a side elevational view of an outer hexagon round screw without socket,

FIG. 2 a top view of the embodiment of FIG. 1,

FIG. 3 a side elevational and partially sectional view of an outer hexagon round screw with the socket shaped like around hexagon socket,

FIG. 4 a top view of the embodiment of FIG. 3,

FIG. 5 a sectional view of the engagement of the scraping piston at the start of the scraping process,

FIG. 6 a sectional view of the engagement of the scraping piston after termination of the scraping process,

FIG. 7 a sectional view of the scraping by employing a piston for the socket formation,

FIG. 8 shows schematically the cutting process of a wire,

FIG. 9 shows schematically a first stage of extruding,

FIG. 10 shows schematically a second stage of finishing upsetting, marking and trimming,

FIG. 11 shows schematically the scraping process,

FIG. 12 shows schematically the burring process.

### DESCRIPTION OF INVENTION AND PREFERRED EMBODIMENT

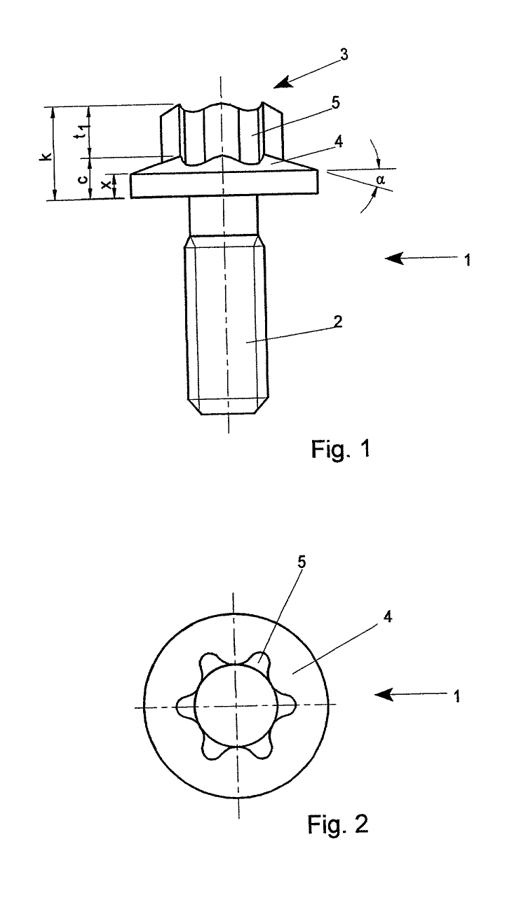

The outer hexagon round screw according to the present invention is illustrated in a side elevational view and in a top view in FIGS. 1 and 2. The head 3 follows to a screw shaft 2, wherein the head 3 includes a flange 4 and a region with an outer hexagon round contour 5 for force engagement. The screw shaft can have windings of any commercial and commonly used winding system. The flange 4 transitions with its slope 4.1 at an angle alpha into the region of the outer hexagon round profile 5. The slope is the rise of the flange from the outer diameter and extending up to the inner enveloping circle of the outer hexagon round. The angle alpha amounts in the case illustrated to 15 degrees. The head 3 exhibits an overall head height k, wherein the head height k is essentially composed out of the force engagement height t₁ and the outer hexagon round contour 5 and out of the maximum height c of the flange 4. The flange 4 exhibits a cylindrical region with the height x.

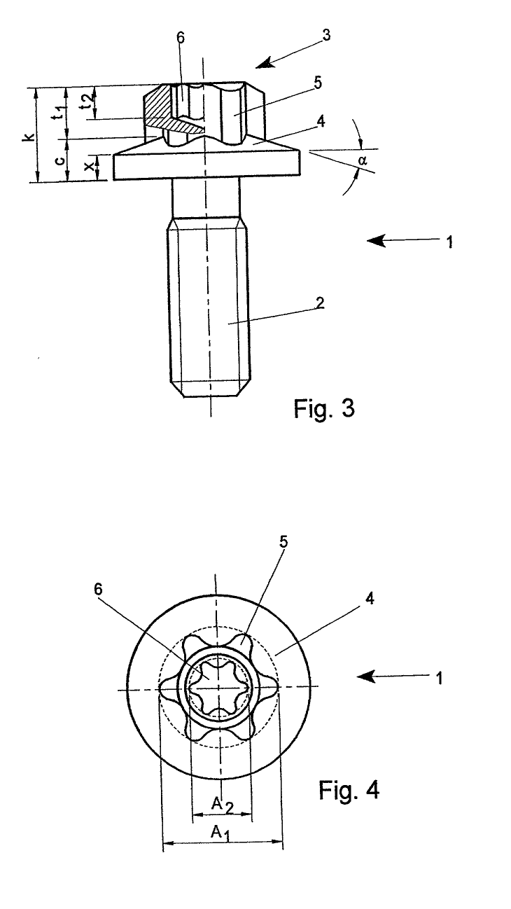

The flange 4 follows with its slope 4.1 under an angle alpha immediately to the round hexagon cap contour 5. A socket 6 in the form of an internal hexagon round is disposed in the screw head 3 according to FIGS. 3 and 4. This is directed analogously to the contour of the outer hexagon round profile. The depth t₂ of the internal hexagon round 6 amounts to about 40 percent of the height k of the head 3. The wall thickness between the socket and the outer hexagon round contour should amount to no more than 60 percent of the outer enveloping circle of the outer hexagon round profile depending on the outer enveloping circle of the respective inner profile.

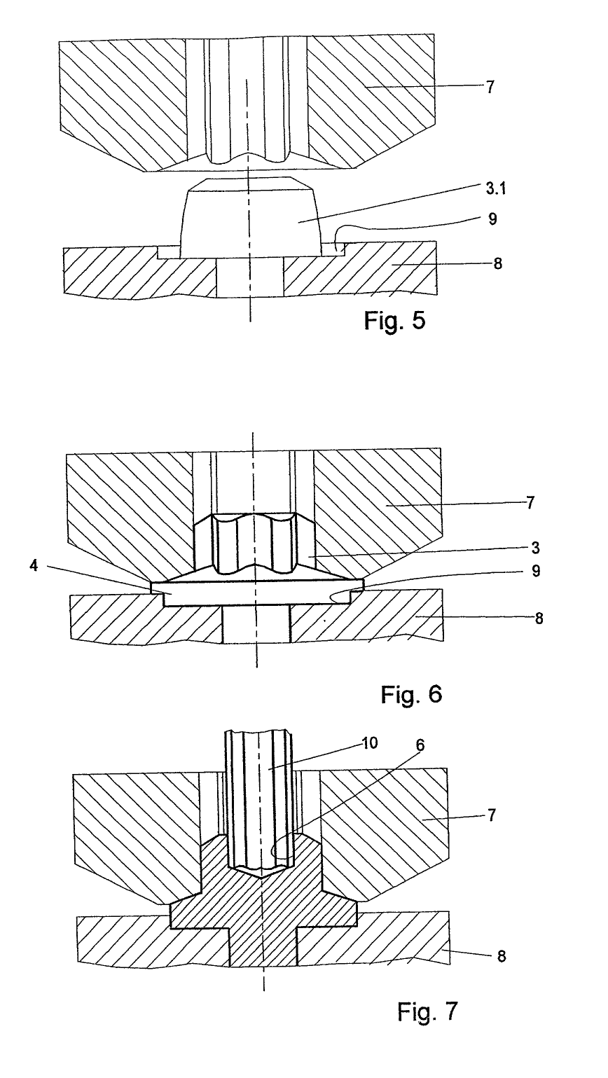

The engagement and attack of the scraping piston 7 at the start and after termination of the scraping process is illustrated in FIGS. 5 and 6 in a longitudinal sectional view. The scraping begins with the placement of the piston and ends in the position shown in FIG. 6. The scraping is performed by moving the scraping piston 7 in a vertical direction back and forth as is shown in FIG. 5. A counter tool 8 with a recess 9 engages at the bottom side of the pre-form 3.1 of the head, wherein the backside of the flange and the outer diameter of the flange are formed in the recess 9 during scraping. The counter tool 8 is rigid. The forming of the backside of the flange and the outer diameter of the flange are in principle independent steps relative to the scraping process. However, forming of the backside of the flange and the outer diameter of the flange have to be performed before any cutting can take place. Finally there is performed a cutting of the flange 4, which determines the outer diameter of the flange.

If a socket 6 was formed prior to the scraping, then a piston 10 engages into the socket 6 during scraping, wherein the piston 10 reaches through the scraping piston 7 (FIG. 7). This avoids that material flows into the socket 6 during scraping. FIG. 7 contains the possibility of using an inner contour for both scraping or upsetting and, respectively, compression molding.

It is optional according to FIG. 7 to obtain an inner contour either by scraping or by compression molding while simultaneously producing the outer hexagon round symmetry.

It is alternatively also possible to form the socket simultaneously with the piston during scraping. The piston can serve at the same time as an ejector here. A stripping sleeve can be employed for ejection also instead of the piston. It is also possible according to an embodiment not illustrated to generate the screw head with outer hexagon round, inner contour and flange by the method combination of upsetting, compression molding, and socket formation.

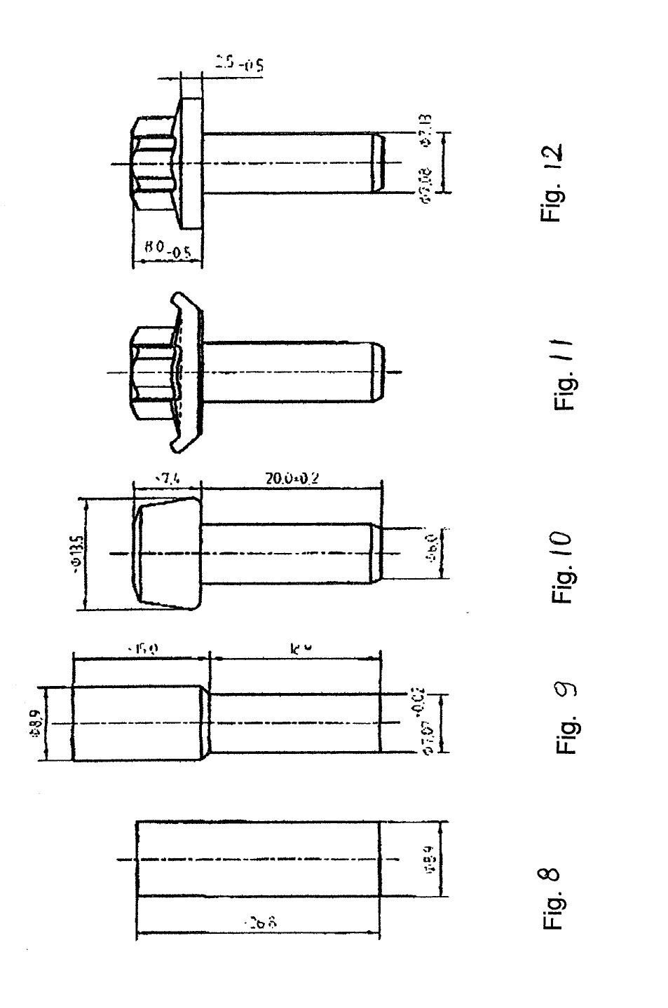

FIGS. 8 through 12 show schematically the change from a cut wire or from a blank to a formed fastener.

FIG. 8 shows schematically the cutting process of a wire into individual blanks illustrated in Fig., where a blank cut from a wire is illustrated.

A first stage of extruding is shown in FIG. 9, where the section of the blank is reduced in diameter. A second stage of finishing upsetting, marking and stamping, as well as trimming and clipping follows in FIG. 10 and gives a pre-form of the head.

The third stage of scraping is shown in FIG. 11 essentially giving form to the head for gripping the head with a tool. FIG. 12 shows schematically the burring process for obtaining the final head of the fastener.

The present invention method clearly avoids the extrusion incline according to U.S. Pat. No. 4,239,834.

It will be understood that each of the elements described above, or two or more together, may also find a useful application in other types of screw cap configurations and fastener producing procedures differing from the types described above.

While the invention has been illustrated and described as embodied in the context of an outer hexagon round screw, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An outer hexagon round screw in the kind of a Torx screw with a head (3), comprising an outer hexagon round contour (5) assuring the force engagement and a flange (4) with a slope (4.1) reaching at an angle (alpha) in the direction toward the outer hexagon round contour (5), wherein the slope (4.1) of the flange (4) follows immediately at the outer hexagon round contour (5), wherein the overall height (k) of the head (3) is decreased by at least about 15 percent, wherein the height (t1) of the outer hexagon round contour (5) assures a reliable force engagement capable of loading to screws to one hundred percent of their stretching limit.

2. The outer hexagon round screw according to claim 1 wherein the slope (4.1) of the flange (4) exhibits an angle (alpha) of from about 12 to 18 degrees in the direction of the outer hexagon round contour (5).

3. The outer hexagon round screw according to claim 1 wherein the slope (4.1) of the flange (4) exhibits an angle (alpha) of essentially about 15 degrees.

4. The outer hexagon round screw according to claim 1 wherein the ratio of the overall height (k) to the height (t₁) of the outer hexagon round profile (5) amounts to from about 1.5 to 2.5.

5. The outer hexagon round screw according to claim 1 wherein the ratio of the overall height (k) of the head relative to the height (t1) of the outer hexagon round profile (5) amounts to about 2.

6. The outer hexagon round screw according to claim 1 wherein the head is furnished with a socket (6).

7. The outer hexagon round screw according to claim 6 wherein the depth of the socket (6) amounts to from about 20 percent to 50 percent of the overall height (k) of the head.

8. The outer hexagon round screw according to claim 6 wherein the socket (6) is formed in the shape of an inner profile.

9. The outer hexagon round screw according to claim 6 wherein the socket (6) is formed in the shape of an internal hexagon round profile.

10. The outer hexagon round screw according to claim 6 wherein the socket (6) is formed in the shape of an internal hexagon.

11. The outer hexagon round screw according to claim 6 wherein the socket (6) is formed in the shape of an internal multiple toothing.

12. The outer hexagon round screw according to claim 6 wherein the wall thickness between the socket (6) and the outer hexagon profile (5) amounts to no more than 60 percent of the outer enveloping circle (A2) of the outer hexagon round profile (5) depending on the outer enveloping circle (A1) of the respective internal profile (6).

13. A method for the production of an outer hexagon round screw having a head (3) comprising an outer hexagon round contour (5) assuring a force engagement and a flange (4) with a slope (4.1) reaching toward the outer hexagon round contour (5) under an angle (alpha), wherein a cylindrical raw blank is reduced in its cross-section and wherein a pre-form (3.1) of the head (3) is generated in the later head region, wherein the production of the flange (4) and of the outer hexagon round contour (5) is performed either by scraping with a scraping tool or by upsetting and compression molding, wherein additionally a socket is generated in the head region.

14. The method according to claim 13 wherein material is scraped out of the region which forms the outer hexagon round contour into the flange region and forms the flange (4) by a scraping piston (7) with an inner contour corresponding to the outer hexagon round contour (5) to be generated and with a contour expanding in the scraping direction corresponding to the angle (alpha) of the flange (4) and wherein a counter tool (8) containing a recess (9) engages at the bottom side of the pre-form (3.1) of the head (3), wherein the lower side of the flange (4) and the outer contour of the flange (4) are formed in the recess (9) of the counter tool (8) during scraping and wherein the cylindrical region of the flange (4) is generated by a final burring if required.

15. The method according to claim 13 wherein a socket (6) is generated in the head region prior to or during scraping.

16. The method according to claim 15 wherein a piston (10) corresponding to the socket (6) engages into the socket (6) or engages in the socket (6) through the scraping piston (7) during the scraping.

17. The method according to claim 15 wherein the piston (10) serves as an ejector for disengaging the head (3) from the scraping piston (7).

18. The method according to claim 13 wherein a stripping sleeve serves for ejection.

19. A method for the production of an outer hexagon round screw comprising the steps
reducing a cylindrical raw blank in its cross-section;
generating a pre-form of the head in a later head region;
performing a production of a flange and of an outer hexagon round contour by scraping with a scraping tool or by upsetting and compression molding;
generating a socket is generated in the head region for obtaining a head comprising an outer hexagon round contour assuring a force engagement with a tool and a flange with a slope reaching toward the outer hexagon round contour under an angle (alpha),

20. The method according to claim 19 further comprising
scraping material out of a region which forms the outer hexagon round contour into the flange region;
forming the flange by a scraping piston with an inner contour corresponding to the outer hexagon round contour to be generated and with a contour expanding in the scraping direction corresponding to the angle (alpha) of the flange; and
engaging at the bottom side of a pre-form of the head with a counter tool containing a recess;
forming the lower side of the flange and the outer contour of the flange in the recess of the counter tool during scraping; and
generating a cylindrical region of the flange by a final burring.

21. An outer hexagon round screw comprising
a head cap including
an outer hexagon round contour assuring a force engagement by a tool;
a flange having a slope reaching at an angle (alpha) in a direction toward the outer hexagon round contour, wherein the slope of the flange follows immediately at the outer hexagon round contour, wherein the overall height (k) of the head (3) is substantially decreased, wherein the height (t1) of the outer hexagon round contour assures a reliable force engagement with a tool.

22. The outer hexagon round screw according to claim 21
wherein the slope of the flange exhibits an angle (alpha) of from about 12 to 18 degrees in the direction of the outer hexagon round contour;
wherein the ratio of the overall height (k) to the height (t1) of the outer hexagon round profile amounts to from about 1.5 to 2.5;
wherein the head is furnished with a socket;
wherein a depth of the socket amounts to from about 20 percent to 50 percent of the overall height (k) of the head;
wherein the wall thickness between the socket and the outer hexagon profile amounts to no more than 60 percent of the outer enveloping circle (A2) of the outer hexagon round profile depending on the outer enveloping circle (A1) of the respective internal profile.
